(19) United States
(12) Patent Application Publication
(10) Pub. No.: US 2010/0263015 A1
(43) Pub. Date: Oct. 14, 2010

(54) Wireless Interface for Set Top Box

(75) Inventors: Siddharth Pandey, Irving, TX (US); Enrique Ruiz Velasco Fonseca, Flower Mound, TX (US)

Correspondence Address: VERIZON;PATENT MANAGEMENT GROUP, 1320 North Court House Road, 9th Floor, ARLINGTON, VA, 22201-2909, US

(73) Assignee: Verizon Patent and Licensing Inc., Basking Ridge, NJ (US)

(21) Appl. No.: 12/420,877

(22) Filed: Apr. 9, 2009

(51) Int. Cl. H04N 7/16; G10L 21/00; H04N 7/173

(52) U.S. Cl. 725/153; 455/41.2; 704/275; 725/106; 455/466

(57) ABSTRACT

A method includes receiving data from a service provider, where the data includes an interactive element. The method may also include outputting the data to an output device and receiving a voice command from a user, where the voice command is associated with the interactive element. The method may further include transmitting, via a wireless protocol, an instruction to a user device associated with the user, where the instruction indicates that a telephone call is to be placed from the user device or a text message is to be transmitted from the user device.

### BACKGROUND INFORMATION

Set top boxes are used to receive signals, such as video signals, audio signals and multi-media signals, from service providers. The set top box decodes the received signals and outputs information for viewing or playing by an output device, such as a television. Interfacing with a set top box typically requires that a user input commands to the set top box via a remote control device. Many conventional remote control devices use infrared (IR) signals to transmit commands to the set top box. The set top box receives an IR signal from the remote control device and performs the desired function based on the particular signal/command.

### BRIEF DESCRIPTION OF THE DRAWINGS

FIG. 1 illustrates an exemplary network in which systems and methods described herein may be implemented;

FIG. 2 illustrates an exemplary configuration of a communication device or user device of FIG. 1;

FIG. 3 illustrates an exemplary configuration of logic components implemented in the communication device of FIG. 2; and

FIGS. 4-6 are flow diagrams illustrating exemplary processing by various devices illustrated in FIG. 1.

### DETAILED DESCRIPTION OF PREFERRED EMBODIMENTS

The following detailed description refers to the accompanying drawings. The same reference numbers in different drawings may identify the same or similar elements. Also, the following detailed description does not limit the invention.

Implementations described herein relate to using voice communications or other communications to control a device, such as a set top box. In one exemplary implementation, a set top box may perform speech recognition on a user's voice command to control an output device, such as a television. The set top box may also accept commands associated with information displayed on the television. For example, the set top box may receive a command associated with information displayed on the television, and transmit an instruction message to a user's telephone device to initiate a telephone call, send a text message, or initiate/send another communication, based on the particular command. The instruction may be transmitted from the set top box to the user's telephone device using a wireless protocol. In some implementations, information received by the user's telephone device may be forwarded to the set top box and displayed for the user. In another exemplary implementation, the set top box and the user's telephone device may exchange audio information associated with a telephone call to allow the user to use the set top box and/or television to carry on a telephone conversation.

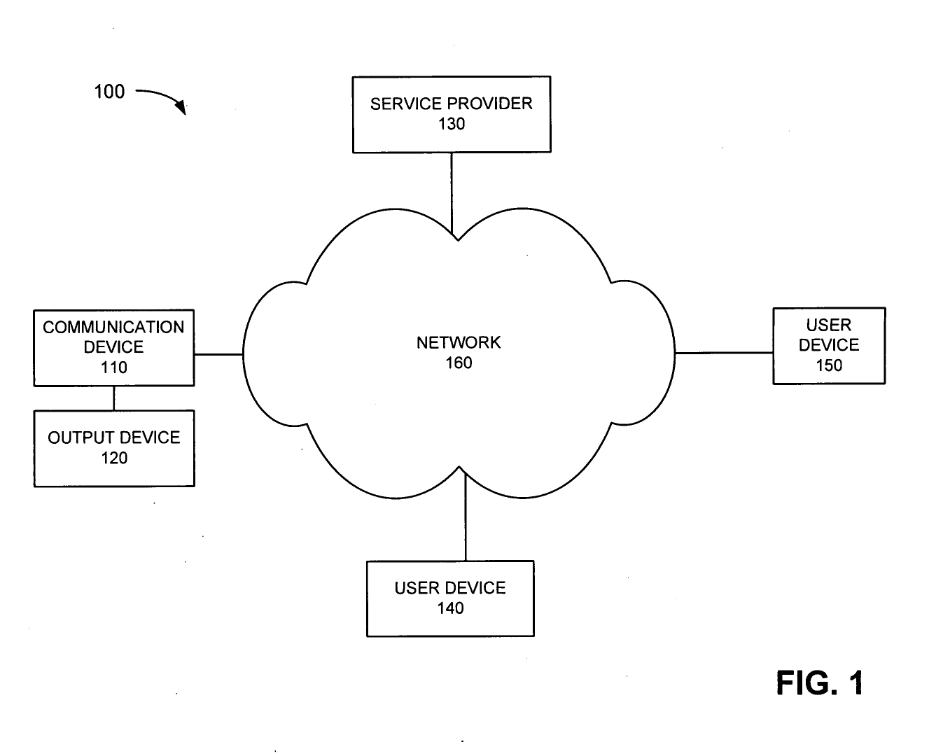

FIG. 1 is a block diagram of an exemplary network 100 in which systems and methods described herein may be implemented. Network 100 may include communication device 110, output device 120, service provider 130, user device 140, user device 150 and network 160.

Communication device 110 may include any type of device that is able to receive data, such as text data, video data, image data, audio data, multi-media data, etc., transmitted from a source, such as service provider 130. Communication device 110 may decode the data and output the data to output device 120 for viewing or playing. In an exemplary implementation, communication device 110 may include a set top box used to decode incoming multi-media data, such as multi-media data received from a television service provider, a cable service provider, a satellite system, a wireless system or some other wired, wireless or optical communication medium. The term “set top box” as used herein should be construed to include any device used to receive signals from an external source and output the signals for viewing or playing. In some implementations, communication device 110 may forward the decoded data for viewing or playing by another device, such as output device 120. In other implementations, communication device 110 may play and display the decoded media.

For example, in some implementations, communication device 110 may include some type of computer, such as a personal computer (PC), laptop computer, home theater PC (HTPC), etc., that is able to receive incoming data and decode the incoming data for output to a display, which may be included with communication device 110.

Output device 120 may include any device that is able to output/display various media, such as a television, monitor, PC, laptop computer, HTPC, a personal digital assistant (PDA), a web-based appliance, a mobile terminal, etc. In an exemplary implementation, output device 120 may receive multi-media data from communication device 110 and display or play the media.

Service provider 130 may include one or more computing devices, servers and/or backend systems that are able to connect to network 160 and transmit and/or receive information via network 160. In an exemplary implementation, service provider 130 may provide multi-media information, such as television shows, movies, sporting events, podcasts or other media presentations to communication device 110 for output to a user/viewer. In one implementation, service provider 130 may provide multi-media data to communication device 110 that includes interactive elements, such as interactive elements within television shows or advertisements, as described in detail below.

User devices 140 and 150 may each include any device or combination of devices capable of transmitting and/or receiving voice signals, video signals and/or data to/from a network, such as network 160. In one implementation, user devices 140 and 150 may each include any type of communication device, such as a plain old telephone system (POTS) telephone, a voice over Internet protocol (VoIP) telephone (e.g., a session initiation protocol (SIP) telephone), a wireless or cellular telephone device (e.g., a personal communications system (PCS) terminal that may combine a cellular radiotelephone with data processing and data communications capabilities, a PDA that can include a radiotelephone, or the like), a wireless headset, a Bluetooth or other wireless accessory, etc. User devices 140 and 150 may each connect to network 160 via any conventional technique, such as wired, wireless, or optical connections.

Network 160 may include one or more wired, wireless and/or optical networks that are capable of receiving and transmitting data, voice and/or video signals, including multi-media signals that include voice, data and video information. For example, network 160 may include one or more public switched telephone networks (PSTNs) or other type of switched network. Network 160 may also include one or more wireless networks and may include a number of transmission towers for receiving wireless signals and forwarding the wireless signals toward the intended destinations. Network 160 may further include one or more packet switched networks, such as an Internet protocol (IP) based network, a local area network (LAN), a wide area network (WAN), a personal area network (PAN) (e.g., a wireless PAN), an intranet, the Internet, or another type of network that is capable of transmitting data.

The exemplary configuration illustrated in FIG. 1 is provided for simplicity. It should be understood that a typical network may include more or fewer devices than illustrated in FIG. 1. For example, network 100 may include additional elements, such as switches, gateways, routers, backend systems, etc., that aid in routing information, such as media streams from service provider 130 to communication device 110. In addition, although communication device 110, output device 120, service provider 130 and user devices 140 and 150 are shown as separate devices in FIG. 1, in other implementations, the functions performed by two or more of these devices may be performed by a single device or platform.

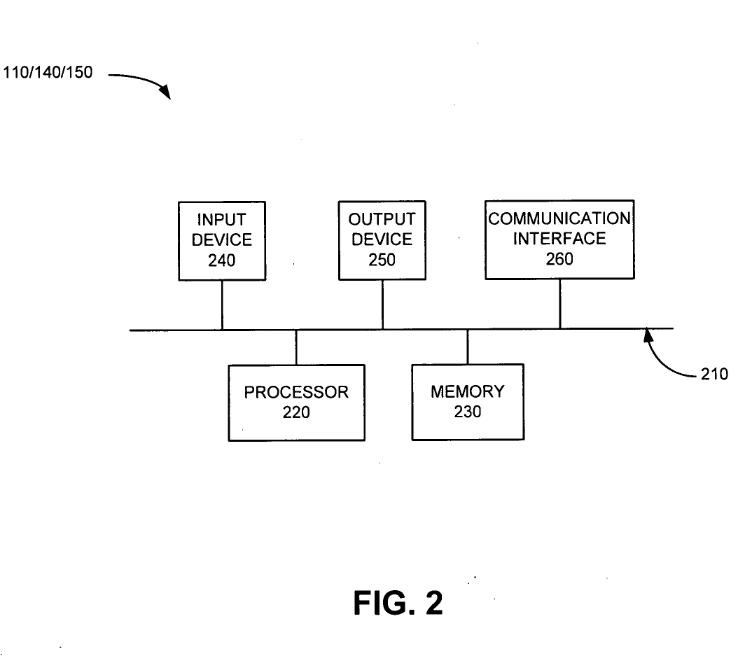

FIG. 2 illustrates an exemplary configuration of communication device 110. User devices 140 and 150 may be configured in a similar manner. Referring to FIG. 2, communication device 110 may include a bus 210, a processor 220, a memory 230, an input device 240, an output device 250 and a communication interface 260. Bus 210 may include a path that permits communication among the elements of communication device 110.

Processor 220 may include one or more processors, microprocessors, or processing logic that may interpret and execute instructions. Memory 230 may include a random access memory (RAM) or another type of dynamic storage device that may store information and instructions for execution by processor 220. Memory 230 may also include a read only memory (ROM) device or another type of static storage device that may store static information and instructions for use by processor 220. Memory 230 may further include a solid state drive (SDD). Memory 230 may also include a magnetic and/or optical recording medium and its corresponding drive.

Input device 240 may include a mechanism that permits a user to input information to communication device 110, such as a keyboard, a keypad, a mouse, a pen, a microphone, a touch screen, voice recognition and/or biometric mechanisms, etc. Input device 240 may also include mechanisms for receiving input via a remote control device, such as a remote control device that sends commands via IR signals. Output device 250 may include a mechanism that outputs information to the user, including a display, a printer, a speaker, etc.

Communication interface 260 may include any transceiver-like mechanism that communication device 110 may use to communicate with other devices (e.g., output device 120, user devices 140 and 150) and/or systems. For example, communication interface 260 may include mechanisms for communicating via network 160, which may include a wired, wireless or optical network. In an exemplary implementation, communication interface 260 may include one or more radio frequency (RF) transmitters, receivers and/or transceivers and one or more antennas for transmitting and receiving RF data via network 160, which may include a wireless PAN or other relatively short distance wireless network. For example, communication interface 260 may include a Bluetooth interface, a Wi-Fi interface or some other wireless interface for communicating with other devices in network 100, such as user devices 140 and 150. Communication interface 260 may also include a modem or an Ethernet interface to a LAN. Alternatively, communication interface 260 may include other mechanisms for communicating via a network, such as network 160.

The exemplary configuration illustrated in FIG. 2 is provided for simplicity. It should be understood that communication device 110 and/or user devices 140 and 150 may include more or fewer devices than illustrated in FIG. 2. For example, various modulating, demodulating, coding and/or decoding components, one or more power supplies or other components may be included in one or more of communication device 110, user device 140 and user device 150.

Communication device 110 may perform processing associated with interacting with output device 120, user device 140 and other devices in network 100. For example, communication device 110 may perform processing associated with receiving voice commands and initiating various processing based on the voice commands, such as controlling output device 120. Communication device 110 may also perform processing associated with initiating telephone calls, text messages, electronic mail (email) messages, instant messages (IMs), mobile IMs (MIMs), short message service (SMS) messages, etc. User device 140, as described in detail below, may also perform processing associated with establishing communications with communication device 110 and using communication device 110 to display various call-related information, as described in detail below. Communication device 110 and user device 140 may perform these operations in response to their respective processors 220 executing sequences of instructions contained in a computer-readable medium, such as memory 230. A computer-readable medium may be defined as a physical or logical memory device. The software instructions may be read into memory 230 from another computer-readable medium (e.g., a hard disk drive (HDD), SSD, etc.), or from another device via communication interface 260. Alternatively, hard-wired circuitry may be used in place of or in combination with software instructions to implement processes consistent with the implementations described herein. Thus, implementations described herein are not limited to any specific combination of hardware circuitry and software.

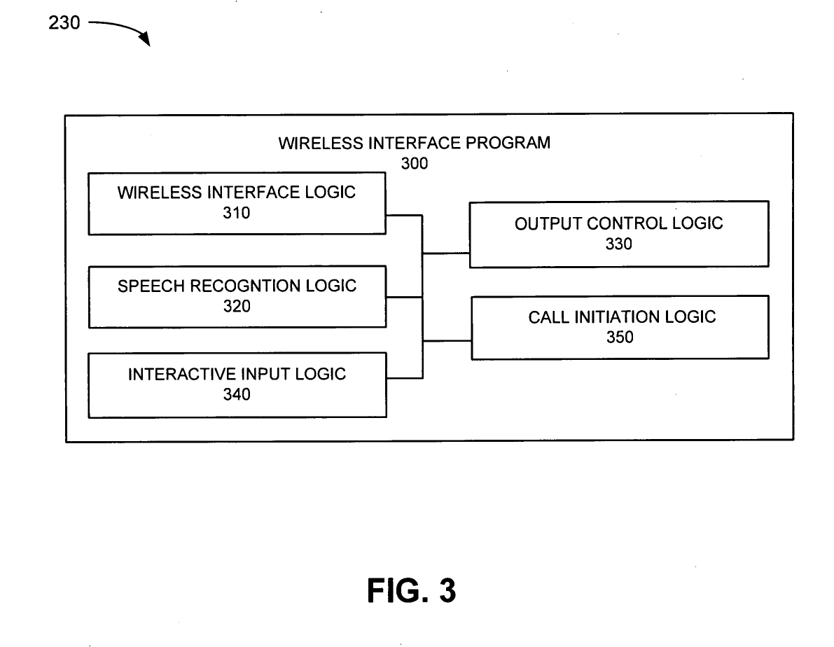

FIG. 3 is an exemplary functional block diagram of components implemented in communication device 110 of FIG. 2. In an exemplary implementation, all or some of the components illustrated in FIG. 3 may be stored in memory 230. For example, referring to FIG. 3, memory 230 may include wireless interface program 300.

Wireless interface program 300 may include a software program executed by processor 220 that allows communication device 110 to communicate with wired and wireless devices, such as user devices 140 and 150. In an exemplary implementation, wireless interface program 300 may include wireless interface logic 310, speech recognition logic 320, output control logic 330, interactive input logic 340 and call initiation logic 350. Wireless interface program 300 and its various logic components are shown in FIG. 3 as being included in communication device 110. In alternative implementations, these components or a portion of these components may be located externally with respect to communication device 110. For example, in some implementations, one or more of the components of wireless interface program 300 may be located in or executed by output device 120 or located in a device coupled to communication device 110 via a universal serial bus (USB) interface.

Wireless interface logic 310 may include logic used to communicate with other devices using a wireless protocol. For example, wireless interface logic 310 may include a Bluetooth interface, a Wi-Fi interface or another wireless interface for communicating with other devices over, for example, a wireless PAN. In some implementations, wireless interface logic 310 may be included on a USB dongle or other device that may be coupled to a USB port or other type of port on communication device 110.

Speech recognition logic 320 may include logic to perform speech recognition on voice data provided by one or more parties. For example, speech recognition logic 320 may convert voice data received from a party associated with user device 140 into a command corresponding to the voice data. In some implementations, speech recognition logic 320 may be designed to identify particular terms/phrases that may be associated with watching television, such as “turn on,” “channel X,” where X may be any number, “volume up,” “volume down,” “go back,” “record,” etc. Speech recognition logic 320 may also be designed to identify particular terms/phrases that may be associated with making telephone calls or sending other communications, such as text messages. For example, speech recognition logic 320 may be designed to identify phrases such as “call,” “send text message,” etc. In an exemplary implementation, speech recognition logic 320 may include a voice over extensible markup language (VoXML) application to convert voice input into corresponding text data.

Output control logic 330 may include logic to display various information on, for example, output device 120. For example, output control logic 330 may output information associated with an incoming call, such as a call received by user device 140, to output device 120. As an example, output control logic 330 may output caller identification information (e.g., the name of the caller and/or the telephone number of the caller) for an incoming call received by user device 140 for display on output device 120. Output control logic 330 may also display other notification information, such as information indicating that a voice mail message has been left for a user of user device 140.

Interactive input logic 340 may include logic that receives input associated with an interactive element displayed on output device 120. For example, communication device 110 may receive an interactive television advertisement provided by service provider 130, where the interactive ad includes a telephone number to call for ordering a particular product. In other instances, communication device 110 may receive programming associated with an interactive television show in which the user may provide input, such as vote for a contestant, etc. In each case, interactive input logic 340 may allow a user to simply provide a voice command (e.g., “call”, “call X,” where X is the advertiser's name, etc.) or select a displayed telephone number or other identifier to initiate a telephone call, send a text message, etc., as described in more detail below.

Call initiation logic 350 may include logic that outputs information and/or performs control actions based on information received by communication device 110. For example, call initiation logic 350 may receive information from interactive input logic 340 and signal user device 140 to place a call, send a text message, display certain information, etc., based on the received input, as described in detail below.

Communication device 110, as described above, may receive information from service provider 130 and output information for display to output device 120. Communication device 110, via wireless interface program 300, may also interact with users to perform various functions with respect to controlling output device 120, handling incoming/outgoing calls and performing other functions for users, as described in detail below.

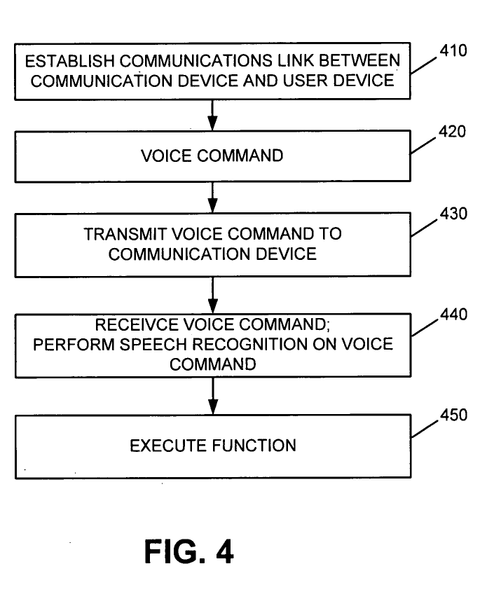

FIG. 4 is a flow diagram illustrating exemplary processing associated with communication device 110 interacting with user device 140. Processing may begin with a user of user device 140 coming into relatively close proximity with communication device 110. For example, assume that a user of user device 140 walks into his/her home, where communication device 110 is located. Further assume that user device 140 is a cellular phone, PDA or some other wireless device used to make and receive telephone calls, text messages, SMS messages, IMs, email messages, etc., and that user device 140 includes a Bluetooth interface or other wireless interface that allows user device 140 to “pair up” and communicate wirelessly with other devices, such as other devices that include a Bluetooth interface. In some implementations in which user device 140 is a cellular device, user device 140 may also include a Bluetooth accessory (e.g., an earpiece) that is able to pair up with user device 140 (e.g., a mobile handset) or other devices, such as communication device 110. As discussed above, wireless interface program 300 may include wireless interface logic 310 that includes a Bluetooth interface that allows communication device 110 to pair up with other Bluetooth-enabled devices. Further assume that user device 140 and communication device 110 establish a communications link (act 410). For example, assume that one or both of communication device 110 and user device 140 are in a “discoverable” state and that the other of these devices discovers the discoverable device, exchanges communications and pairs up. Communication device 110 and user device 140 may then communicate via the Bluetooth protocol. Alternatively, or in addition to user device 140 pairing up with communication device 110, a Bluetooth accessory (e.g., an earpiece) associated with user device 140 may pair up with communication device 110.

Assume that the user associated with user device 140 wishes to turn on output device 120 (e.g., a television). The user may voice a command to turn on output device 120, such as “turn on TV” (act 420). In one implementation, assume that user device 140 includes a microphone (either located on a Bluetooth accessory, such as a Bluetooth earpiece, paired with communication device 110 or on user device 140 itself, which may be paired with communication device 110). In either case, the Bluetooth accessory included with user device 140 or user device 140 may transmit the voice command to communication device 110 via Bluetooth communications (act 430).

Communication device 110 may receive the voice command (act 440). For example, wireless interface logic 310 may receive the voice data transmitted via Bluetooth and may forward the voice data to speech recognition logic 320. Speech recognition logic 320 may then identify the voiced command using speech recognition and forward the identified command to output control logic 330 (act 440). Output control logic 330 may process the command and execute the desired function (act 450). In this example, output control logic 330 may signal communication device 110 to turn on the television set (i.e., output device 120). In other instances, output control logic 330 may signal communication device 110 to lower the volume of output device 120, change the channel, record a program, etc., based on the particular voice command. In this manner, voice commands may be transmitted via Bluetooth or another wireless protocol to control communication device 110 and output device 120.

In other implementations, a remote control device associated with communication device 110 may be equipped with a microphone and speech recognition logic that converts voice commands into appropriate commands and communicates the commands to communication device 110 using, for example, IR communications. In still other implementations, communication device 110 may include a microphone that may be used to directly receive voice commands. Speech recognition logic 320 within communication device 110 may then be used to identify the voice command and perform the appropriate action. In each instance, voice commands may be used to signal communication device 110 to perform various functions with respect to controlling output device 120.

As described above, wireless interface program 300 may be used to facilitate control of communication device 110 and/or output device 120 via voice commands transmitted via Bluetooth or some other wireless protocol. Wireless interface program 300 may also perform other types of functions with respect to interacting with users. For example, wireless interface program 300 may facilitate interaction with information displayed on output device 120, such as initiating calls or text messages or initiating other interactive features, as described in detail below.

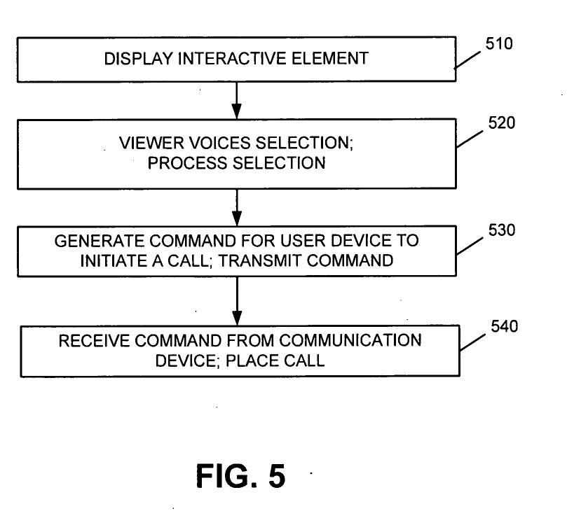

FIG. 5 illustrates exemplary processing associated with initiating communications via communication device 110. Processing may begin with a party watching a television show provided via output device 120. For example, service provider 130 may provide television programming to communication device 110, which decodes and outputs the programming to output device 120. Assume that the programming or an advertisement provided with the programming includes some interactive element. For example, suppose that the programming is associated with a reality television show and output device 120 displays one or more telephone numbers or address identifiers to which a telephone call or text message is to be placed to vote for a contestant. Alternatively, the programming may include an advertisement that includes a telephone number to which a telephone call is to be placed to order a product.

In either case, assume that the interactive element is displayed on output device 120 and the user watching the program views the interactive element (act 510). Further assume that the interactive element includes a list of telephone numbers or text addresses used to vote for different contestants. In this implementation, the viewer may voice “dial X,” when the list of telephone numbers is displayed, where X represents the particular number in the list that the user wishes to call (act 520). Alternatively, when an interactive ad is provided with a toll free number or some other number that is displayed, the user may simply voice “dial,” or “call” or voice other terms/words associated with a displayed advertisement. In each case, the voice command may be interpreted by speech recognition logic 320 of communication device 110 to determine what the user said (act 520). Speech recognition logic 320 may then forward the identified instruction or command to call initiation logic 350.

Call initiation logic 350 may then determine that a call to the selected number should be initiated from user device 140. For example, call initiation logic 350 may determine that a call associated with the interactive element displayed on output device 120 is to be made from a device that is paired with communication device 110. Continuing with the example discussed above with respect to FIG. 4, assume that user device 140 is paired with communication device 110 using Bluetooth or some other wireless protocol. Call initiation logic 350 may then generate a command to user device 140 indicating that user device 140 is to place a call to the designated number (act 530). Call initiation logic 350 may forward the command to user device 140 via wireless interface logic 310 (act 530). In one implementation, the command or call initiation message to user device 140 may include the selected telephone number (i.e., the “to” number), along with instructions, a code, or other information indicating that user device 140 is to call that particular telephone number. In other implementations, wireless interface logic 310 may transmit the command to initiate a call to another device (e.g., user device 150, which may be a landline), along with the particular telephone number to call. For example, in some implementations, communication device 110 may output a list of numbers for display by output device 120, where the list of number includes the numbers from which the call may be placed. For example, the list of numbers may include the user's cell phone, home landline phone, etc. In such an implementation, the user may select the number from which the call is to be placed by voicing a selection.

In each case, the receiving device (e.g., user device 140 or user device 150) may receive the command from communication device 110 and automatically place the call to the designated telephone number (act 540). For example, assume that user device 140 is a cellular telephone that receives a Bluetooth communication indicating that a call to the particular number is to be placed. User device 140 may automatically dial the received telephone number to complete the call. In this manner, a user not located within reach of his/her cellular telephone handset (or other user device) may initiate a call from that handset (i.e., user device 140) by simply providing a voice command that is interpreted by communication device 110. Communication device 110 may then use Bluetooth or another wireless communications method/protocol to initiate a call from the user device paired with communication device 110. If multiple devices are paired with communication device 110, communication device 110 may have a pre-stored hierarchy indicating which user device (i.e., user device 140 or user device 150) to contact first to initiate the call.

As described above, communication device 110 may signal user device 140 to place a telephone call to a specified number. In other instances, the interactive element displayed on output device 120 may include a list of text messages to send to a particular destination to, for example, vote for a contestant, receive product information, etc. In such instances, the user may voice “send text X,” where X represents the particular text message in the list that the user wishes to send. In this case, speech recognition logic 320 may identify the command and forward the command to call initiation logic 350. Call initiation logic 350 may then transmit an instruction to user device 140 via wireless interface logic 310, where the instruction indicates that the particular text message is to be sent to a particular destination. The text message destination may be a telephone number or some other identifier displayed on output device 120 and which corresponds to where the text message is to be sent. User device 140 may receive the instruction and automatically send the text message to the appropriate destination. In this manner, a user watching television may send a text message or other communication without having to physically enter any information into his/her user device 140.

In other implementations, other types of information may be selected from information displayed on output device 120 for initiating communications. For example, output device 120 may be used to display an address book/contacts list that includes telephone numbers, screen names/instant message addresses, email addresses, etc., associated with a user of communication device 110. The user may view the address book/contacts list displayed on output device 120, select a friend's name from the list and initiate a call to that party. For example, the user may choose to call a party by simply speaking a name and/or telephone number displayed on the list. Speech recognition logic 320 may identify the voiced name (or number), identify the corresponding telephone number and forward that number to the device of choice (e.g., user device 140) via wireless interface logic 310. The user device of choice (e.g., user device 140) may receive an instruction along with the designated telephone number and automatically place the call to the designated telephone number.

As described above, communication device 110 may interact with output device 120 and user device 140 using voice communications to initiate telephone calls, text messages or other communications. This may facilitate a user making calls and simplify the user's processes associated with making calls. In other instances, the user viewing programming on output device 120 may use a remote control device to select a particular telephone number or text message associated with an interactive element. In these instances, call initiation logic 350 may receive the selection and forward an instruction to user device 140 (or another user device) to place the call, send the text message, etc. In each case, wireless interface program 300 may interact with the user's input and initiate the appropriate communication.

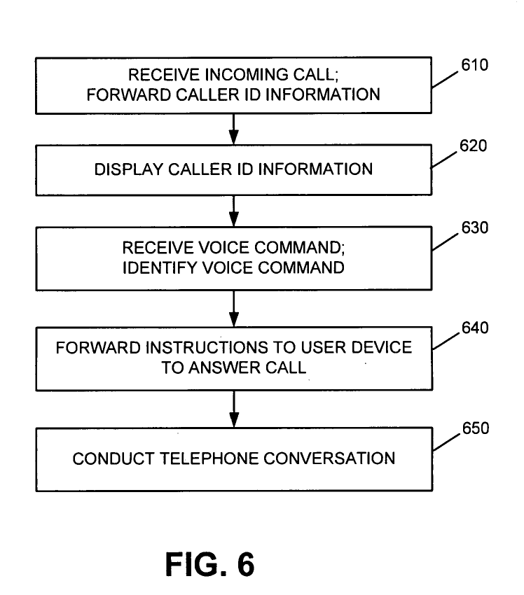

In other implementations, communication device 110 may display information associated with incoming telephone calls received by user device 140. For example, FIG. 6 illustrates exemplary processing with displaying incoming call related information. Processing may begin with user device 140 receiving an incoming call (act 610). Assume that user device 140 is paired with communication device 110 via Bluetooth or some other wireless protocol/method. The caller identification (ID) information, such as the caller's name and/or telephone number may be transmitted from user device 140 to communication device 110 via, for example, Bluetooth (act 610).

Communication device 110 may then output the caller ID information to output device 120 for display to the user (act 620). In this manner, caller ID information from a wireless device, such as user device 140, may be communicated to communication device 110 (e.g., a set top box) and displayed on output device 120 (e.g., a television). Other information from user device 140 may also be transmitted to communication device 110. For example, an indication that a voicemail message has been left for a user associated with user device 140 may be transmitted to communication device 110 and output to output device 120 for display.

In some implementations, when the caller ID information is displayed on output device 120, the user may voice “answer call” or similar language in response to the displayed caller ID information. Speech recognition logic 320 may receive the voice data and identify the voiced command (act 630). Speech recognition logic 320 may then signal call initiation logic 350 to forward a command to user device 140 to answer the call (act 640).

For example, call initiation logic 350 may forward the command to answer the call to user device 140 via wireless interface logic 310 (act 640). In an exemplary implementation, the user viewing programming on output device 120 may then use wireless interface logic 310 and Bluetooth logic in user device 140 to carry on a conversation with the caller (act 650).

For example, voice information from the user may be received by wireless interface logic 310 and forwarded via Bluetooth or another wireless protocol to user device 140, which forwards the voice information to the other party in the telephone conversation. Similarly, voice information from the other party in the telephone conversation may be received by user device 140 and transmitted via Bluetooth or another wireless protocol to wireless interface logic 310. Wireless interface logic 310 may then output the audio via output device 120. In this manner, communication device 110 may facilitate displaying call-related information, as well as answering calls and carrying on conversations.

As described above, user device 140 and communication device 110 may include wireless interfaces, such as Bluetooth interfaces/programs that allow these devices to communicate. In some instances, communication device 110 may provide audio output to a Bluetooth accessory, such as a Bluetooth earpiece. For example, in one implementation, assume that the user associated with user device 140 is watching television and a Bluetooth earpiece associated with user device 140 is paired with communication device 110. In this implementations, communication device 110 may be configured to output the audio portion of the data stream provided by service provider 130 to the Bluetooth earpiece associated with user device 140. That is, wireless interface logic 310 of wireless interface program 300 may stream audio output from service provider 130 to the audio earpiece associated with user device 140. In this manner, a user may be able to listen to television programming over Bluetooth. This feature may be particularly beneficial to users suffering from hearing impairments.

Implementations described herein provide for using speech recognition logic to perform various functions associated with received programming. For example, voice commands may be communicated to a set top box and the set top box may perform a desired function. These functions may include controlling an output device playing the received programming, as well as initiating communications (e.g., phone calls, text messages, etc.) from other devices. This may facilitate communications and also enhance a user's enjoyment with respect to watching programming from a service provider.

The foregoing description of exemplary implementations provides illustration and description, but is not intended to be exhaustive or to limit the embodiments to the precise form disclosed. Modifications and variations are possible in light of the above teachings or may be acquired from practice of the embodiments.

For example, in one implementation described above, a user may conduct a telephone conversation using communication device 110 to relay voice communications to a user's telephone device (e.g., user device 140). In other implementations, a user may conduct a text-based conversation with another party in a similar manner. That is, the user may voice responses to a received text message displayed on output device 120. Speech recognition logic 320 may convert the voiced message into text and wireless interface logic 310 may forward the text message to user device 140 for transmission to the other party.

In addition, features have been described above as using communication device 110 to forward communications to user device 140 for transmission to another party. In other implementations, communication device 110 may include transmission and receiver circuitry to transmit and receive telephone calls, text messages and other communications directly. In these implementations, a user may simply interact with communication device 110 to answer calls, some of which may originally have been forwarded from another device, such as user device 140, and some of which may have been originally received by communication device 110. In either case, the user may use voice communications to answer calls and carry on telephone conversations, text-based communication sessions, etc. In such instances, after a call is forwarded to communication device 110 by user device 140, further interaction with user device 140 may not be needed.

In addition, while series of acts have been described with respect to FIGS. 4-6, the order of the acts may be varied in other implementations. Moreover, non-dependent acts may be implemented in parallel.

It will be apparent that various features described above may be implemented in many different forms of software, firmware, and hardware in the implementations illustrated in the figures. The actual software code or specialized control hardware used to implement the various features is not limiting. Thus, the operation and behavior of the features were described without reference to the specific software code—it being understood that one of ordinary skill in the art would be able to design software and control hardware to implement the various features based on the description herein.

Further, certain portions of the invention may be implemented as “logic” that performs one or more functions. This logic may include hardware, such as one or more processors, microprocessor, application specific integrated circuits, field programmable gate arrays or other processing logic, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method, comprising:
receiving, at a set top box, data from a service provider, the data including an interactive element;
outputting, by the set top box, the data to an output device;
receiving, at the set top box, a voice command from a user, the voice command being associated with the interactive element; and
transmitting, via a wireless protocol, an instruction to a user device associated with the user, wherein the instruction indicates that a telephone call is to be placed from the user device or a text message is to be transmitted from the user device.

2. The method of claim 1, wherein the interactive element includes at least one telephone number and wherein the receiving a voice command comprises:
receiving a voice command selecting one of the at least one telephone number.

3. The method of claim 2, further comprising:
performing speech recognition to identify the selected one telephone number, and wherein the transmitting comprises:
transmitting data including the one telephone number to the user device.

4. The method of claim 2, wherein the user device automatically places a call to the one telephone number to establish telephone communications with a second user, the method further comprising:
receiving, at the set top box, audio communications from the second user that are received by the user device, the audio communications being transmitted to the set top box by the user device via the wireless protocol; and
outputting the audio communications via the set top box.

5. The method of claim 4, further comprising:
receiving, at the set top box, voice communications from the user; and
forwarding, via the wireless protocol, the voice communications to the user device for transmission to the second user.

6. The method of claim 1, wherein the instruction includes information instructing the user device to transmit a text message to an identifier associated with the interactive element.

7. The method of claim 1, wherein the interactive element includes an identifier corresponding to a destination for a text message and wherein the receiving a voice command comprises:
receiving a voice command to transmit the text message to the destination.

8. The method of claim 1, further comprising:
receiving, by the set top box, caller identification information associated with a call received at the user device, the caller identification information being transmitted from the user device to the set top box using a wireless protocol; and
outputting, by the set top box, the caller identification information for display by the output device.

9. The method of claim 1, further comprising:
outputting, by the set top box, a contacts list or address book for display by the output device;
receiving, from the user, voice input selecting a name or identifier in the contacts list or address book; and
forwarding information, by the set top box, to the user device, the information instructing the user device to initiate a call to a telephone associated with the name or identifier.

10. The method of claim 1, further comprising:
receiving a second voice command from the user;
identifying the second voice command; and
performing a control action with respect to the output device based on the identified second voice command.

11. A device, comprising:
a communication interface configured to send and receive communications using a wireless protocol; and
logic configured to:
receive data from a service provider,
output the data to an output device, the output device displaying a telephone number or a text message destination,
receive a voice command from a user, the voice command being associated with selecting the telephone number or the text message destination, and
transmit, via the communication interface, an instruction to a user device associated with the user, wherein the instruction indicates that the user device is to place a telephone call to the telephone number or that the user device is to transmit a text message to the text message destination.

12. The device of claim 11, wherein when transmitting an instruction, the logic is further configured to:
transmit an instruction indicating that the user device is to place a telephone call, wherein the logic is further configured to:
receive audio communications received by the user device that are associated with the telephone call, the audio communications being transmitted to the device using the wireless protocol, and
output the audio communications via the output device.

13. The device of claim 12, wherein the logic is further configured to:
receive voice communications associated with the telephone call from the user, and
forward, via the communication interface, the voice communications to the user device.

14. The device of claim 11, wherein when transmitting an instruction, the logic is configured to:
transmit an instruction indicating that the user device is to transmit a text message to the text message destination.

15. The device of claim 11, wherein the logic is further configured to:
receive, caller identification information associated with a call received by the user device, the caller identification information being transmitted to the device via the wireless protocol, and
output the caller identification information to the output device.

16. The device of claim 11, wherein the logic is further configured to:
output a contacts list or address book for display by the output device,
receive, from the user, voice input selecting a name or identifier in the contacts list or address book, and
forward, via the communication interface, information to the user device, the information instructing the user device to initiate a communication to a device associated with the name or identifier.

17. The device of claim 11, wherein the logic is further configured to:
receive a second voice command from the user,
identify the second voice command, and
perform a control action with respect to the output device based on the identified second voice command.

18. The device of claim 11, wherein the device comprises a set top box and the wireless protocol comprises a Bluetooth protocol.

19. A computer-readable medium having stored thereon sequences of instructions which, when executed by at least one processor, cause the at least one processor to:
receive a data stream from a service provider, the data stream including an interactive element;
output the data stream to an output device;
receive a voice command from a user, the voice command being associated with the interactive element; and
transmit, via a wireless protocol, an instruction to a user device associated with the user, wherein the instruction indicates that a telephone call is to be placed from the user device or a text message is to be transmitted from the user device.

20. The computer-readable medium of claim 19, further including instructions for causing the at least one processor to:
receive a second voice command from the user;
identify the second voice command, and
perform a control action with respect to the output device based on the identified second voice command.
